(19) United States
(12) Patent Application Publication
(10) Pub. No.: US 2019/0353806 A1
(43) Pub. Date: Nov. 21, 2019

(54) RADIATION DETECTOR AND RADIATION TRANSMISSION IMAGE ACQUISITION SYSTEM

(71) Applicant: SHARP KABUSHIKI KAISHA, Sakai City (JP)

(72) Inventors: TAKAYUKI NAGAOKA, Sakai City (JP); SHINSUKE ANZAI, Sakai City (JP)

(21) Appl. No.: 16/381,867

(22) Filed: Apr. 11, 2019

(30) Foreign Application Priority Data
May 16, 2018 (JP) 2018-094805

(51) Int. Cl. G01T 1/29; G01T 1/17; G01N 23/06

(52) U.S. Cl. CPC G01T 1/2921; G01N 23/06; G01T 1/17

(57) ABSTRACT

In a radiation detector, elements that detect radiation and generate charges are arranged in a matrix form. The radiation detector selects and reads out charges, which correspond to a dose of the radiation, row by row at predetermined periods. The radiation detector starts selection of rows from a first row without waiting for completion of readout of one frame which is a period where selection of rows from the first row to a last row is completed.

### BACKGROUND

### 1. Field

The present disclosure relates to a radiation detector, and in particular relates to an indirect type radiation detector and a radiation transmission image acquisition system.

### 2. Description of the Related Art

As a radiation inspection, for example, an indirect type radiation detector is conventionally known (for example, see Japanese Unexamined Patent Application Publication No. 2002-335446). The indirect type radiation detector selects and reads out charges, which correspond to a dose of radiation detected from an inspection object to which radiation (X-ray) is irradiated, row by row at predetermined periods.

Such a radiation detector converts an emission amount of light from a radiation-to-light converter (scintillator), which varies according to a transmission amount of radiation irradiated to an inspection object, into charges of an amount of charges corresponding to the emission amount of light for each of photoelectric light receiving elements (photodiodes) arranged in a row direction and a column direction. The converted charges are accumulated, and image data is generated by reading out the accumulated charges. Thereby, a transmission image of the inspection object can be obtained.

The radiation detector includes a row drive circuit that selects a photoelectric light receiving element in the row direction and a readout circuit that reads out charges accumulated in the photoelectric light receiving element selected by the row drive circuit in parallel in a column direction.

The row drive circuit selects (scans) the photoelectric light receiving elements row by row at predetermined periods from the first row to the last row. Here, a period in which the row drive circuit completes selection of rows from the first row to the last row is defined as one frame. In each selected row, charges accumulated in the photoelectric light receiving elements located in the row are outputted to the readout circuit.

On the other hand, in the radiation detector, even in a state where no radiation is irradiated (hereinafter also referred to as a dark state), charges called dark current (dark current charges) are accumulated in the photoelectric light receiving elements. The dark current charges (hereinafter also referred to as dark current) can be reset by performing a readout operation of the charges accumulated in the photoelectric light receiving elements. Therefore, it is necessary to regularly perform the readout operation even in the dark state (reset operation).

By the way, the radiation detector operates asynchronously with a radiation irradiation apparatus that irradiates radiation to an inspection object. Therefore, in conventional drive timing, when the radiation detector receives a radiation irradiation signal indicating that radiation is irradiated while selecting the middle of a row, it is necessary that the radiation detector starts drive of the first row after waiting until the last row is selected and accumulates charges (hereinafter also referred to as signal charges) by irradiating radiation after resetting charges accumulated so far.

In this way, a reset time from when the radiation irradiation signal is received while the middle of a row is selected to when the accumulated charges are reset after waiting until the last row is selected is considered, so that there is a problem that it is necessary to irradiate radiation for a time longer than necessary to acquire an inspection image.

In this respect, Japanese Unexamined Patent Application Publication No. 2002-335446 describes a configuration where a time required for the reset operation is shortened by changing a drive frequency of the row drive circuit.

However, even in the configuration described in Japanese Unexamined Patent Application Publication No. 2002-335446, it is also necessary to wait one frame period at the longest, so that a problem occurs where it is difficult to shorten radiation irradiation time when the radiation irradiation signal is received while a row is being selected.

Therefore, it is desirable to provide a radiation detector and a radiation transmission image acquisition system which can shorten the radiation irradiation time when the radiation irradiation signal is received while a row is being selected.

### SUMMARY

According to aspects of the disclosure, there are provided radiation detectors of first to third aspects and radiation transmission image acquisition systems of first and second aspects described below.

(1) Radiation Detector of the First Aspect

The radiation detector of the first aspect according to the present disclosure is a radiation detector where elements that detect radiation and generate charges are arranged in a matrix form and which selects and reads out charges, which correspond to a dose of the radiation, row by row at predetermined periods. The radiation detector starts selection of rows from a first row without waiting for completion of readout of one frame which is a period where selection of rows from the first row to a last row is completed.

(2) Radiation Transmission Image Acquisition System of the First Aspect

The radiation transmission image acquisition system of the first aspect according to the present disclosure includes the radiation detector according to the first aspect of the present disclosure and an information processing apparatus that processes charges read out by the radiation detector into an image. The radiation detector transfers the read-out charges to the information processing apparatus only when radiation irradiation to the inspection object is detected.

(3) Radiation Detector of the Second Aspect

The radiation detector of the second aspect according to the present disclosure is a radiation detector where elements that detect radiation and generate charges are arranged in a matrix form and which detects radiation that transmits through an inspection object. The radiation detector includes a first period in which readout of one frame, which is a period where the charges are selected row by row at predetermined periods and selection of rows from a first row to a last row is completed, is performed, and a second period in which selection from the first row is started by detecting that the radiation is irradiated to the inspection object, and the readout of one frame, which is a period where the charges are selected row by row at predetermined periods and selection of rows from the first row to the last row is completed, is performed. The second period starts without waiting for end of the first period, and a plurality of selected rows occur in a period in which the first period and the second period overlap with each other.

(4) Radiation Transmission Image Acquisition System of the Second Aspect

The radiation transmission image acquisition system of the second aspect according to the present disclosure includes the radiation detector of the second aspect according to the present disclosure and an information processing apparatus that processes charges read out by the radiation detector into an image. The radiation detector transfers the read-out charges to the information processing apparatus only when radiation irradiation to an inspection object is detected.

(5) Radiation Detector of the Third Aspect

The radiation detector of the third aspect according to the present disclosure is a radiation detector where elements that detect radiation and generate charges are arranged in a matrix form and which selects and reads out charges, which correspond to a dose of the radiation detected from an inspection object to which the radiation is irradiated, row by row at predetermined periods. After reading out signals accumulated by the irradiation of radiation, the radiation detector starts selection of rows from a first row without waiting that charges are reset by readout of one frame which is a period where selection of rows from the first row to a last row is completed.

### BRIEF DESCRIPTION OF THE DRAWINGS

FIG. 1 is a block diagram showing a schematic configuration of a radiation transmission image acquisition system including a radiation detector according to an embodiment;

FIG. 2 is a block diagram showing a schematic configuration of the radiation detector in the radiation transmission image acquisition system shown in FIG. 1;

FIG. 3 is a circuit diagram showing a configuration example of one photoelectric light receiving element and a readout circuit connected to the photoelectric light receiving element in a sensor unit;

FIG. 4 is a timing chart showing drive timing of the photoelectric light receiving elements in the radiation detector in a state where no radiation is irradiated;

FIG. 5 is a timing chart showing conventional drive timing;

FIG. 6 is a timing chart showing drive timing of a first embodiment;

FIG. 7 is a timing chart showing drive timing of a second embodiment; and

FIG. 8 is a timing chart showing drive timing of a third embodiment.

### DESCRIPTION OF THE EMBODIMENTS

Hereinafter, embodiments related to the present disclosure will be described with reference to the drawings; In the description below, the same components are denoted by the same reference numerals, and also have the same names and the same functions. Therefore, detailed description of the same components will not be repeated.

### First Embodiment

(Entire Configuration of Radiation Detector)

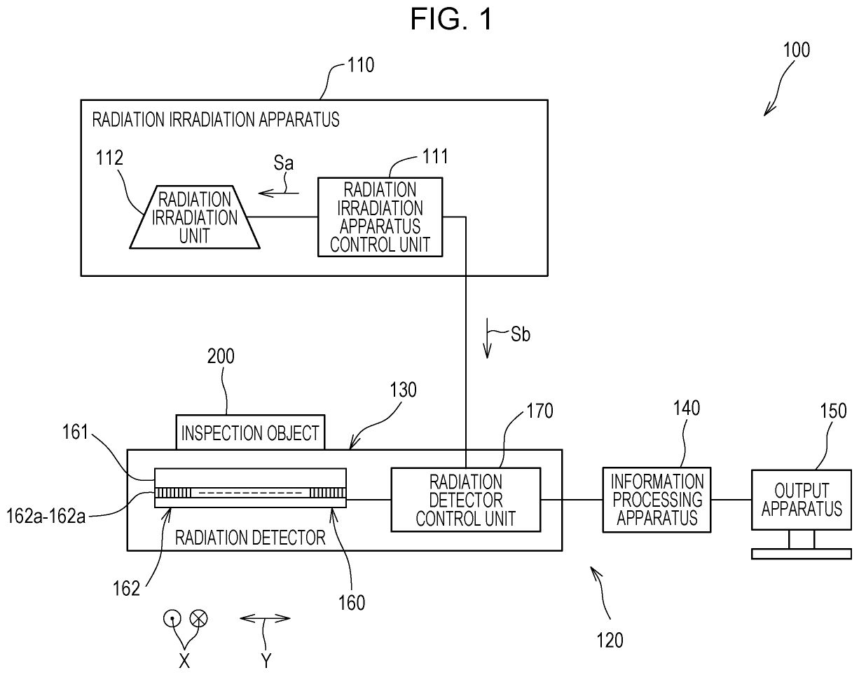

FIG. 1 is a block diagram showing a schematic configuration of a radiation transmission image acquisition system 100 including a radiation detector 130 according to the present embodiment.

As shown in FIG. 1, the radiation transmission image acquisition system 100 includes a radiation irradiation apparatus 110 that irradiates an inspection object 200 with radiation (X-ray) and an image detection apparatus 120 that detects intensity of radiation that transmits the inspection object 200 and outputs an image.

The radiation irradiation apparatus 110 includes a radiation irradiation apparatus control unit 111 and a radiation irradiation unit 112. The radiation irradiation apparatus control unit 111 outputs a radiation irradiation instruction signal Sa that instructs irradiation of radiation and instructs the radiation irradiation unit 112 to irradiate radiation. At this time, the radiation irradiation apparatus control unit 111 outputs a radiation irradiation signal Sb, which indicates that radiation is irradiated, to the image detection apparatus 120, and transmits irradiation timing of the radiation to the image detection apparatus 120. When the radiation irradiation unit 112 receives the radiation irradiation instruction signal Sa from the radiation irradiation apparatus control unit 111, the radiation irradiation unit 112 irradiates radiation toward the inspection object 200.

The image detection apparatus 120 includes a radiation detector 130, an information processing apparatus 140 (personal computer: PC) that processes charges read out by the radiation detector 130 into an image, and an output apparatus 150 (display apparatus).

The radiation detector 130 selects and reads out charges, which correspond to a dose of radiation detected from the inspection object 200 irradiated with radiation, row by row at predetermined periods.

The radiation detector 130 includes a sensor unit 160 (sensor panel) that detects a dose of radiation transmitted through the inspection object 200, and a radiation detector control unit 170.

The sensor unit 160 includes a radiation-to-light converter 161 (for example, scintillator) and an array unit 162 (for example, photodiode array).

The radiation-to-light converter 161 has a function to convert radiation into light (visible light). The radiation-to-light converter 161 emits light whose emission amount corresponds to a transmission amount of the radiation irradiated to the inspection object 200. In the array unit 162, a plurality of photoelectric light receiving elements 162a to 162a (for example, photodiodes) are arranged in a row direction X and a column direction Y. The radiation-to-light converter 161 entirely covers the photoelectric light receiving elements 162a to 162a in the array unit 162. The photoelectric light receiving elements 162a to 162a perform photoelectric conversion according to an emission amount of light from the radiation-to-light converter 161.

The radiation detector 130 converts the emission amount of light from the radiation-to-light converter 161 into charges of an amount of charges corresponding to the emission amount for each photoelectric light receiving element 162a to 162a. The converted charges are accumulated, and the accumulated charges are read out and digitally processed. Thereby, a transmission image of the inspection object 200 is obtained.

The radiation detector control unit 170 detects timing of irradiation of radiation at irradiation timing of radiation of the radiation irradiation signal Sb transmitted from the radiation irradiation apparatus control unit 111. The radiation detector control unit 170 transmits a signal (signal charge) from the array unit 162 when radiation is irradiated to the information processing apparatus 140. The information processing apparatus 140 generates image data based on the signal transmitted from the radiation detector control unit 170 and outputs (displays) the generated image data to the output apparatus 150.

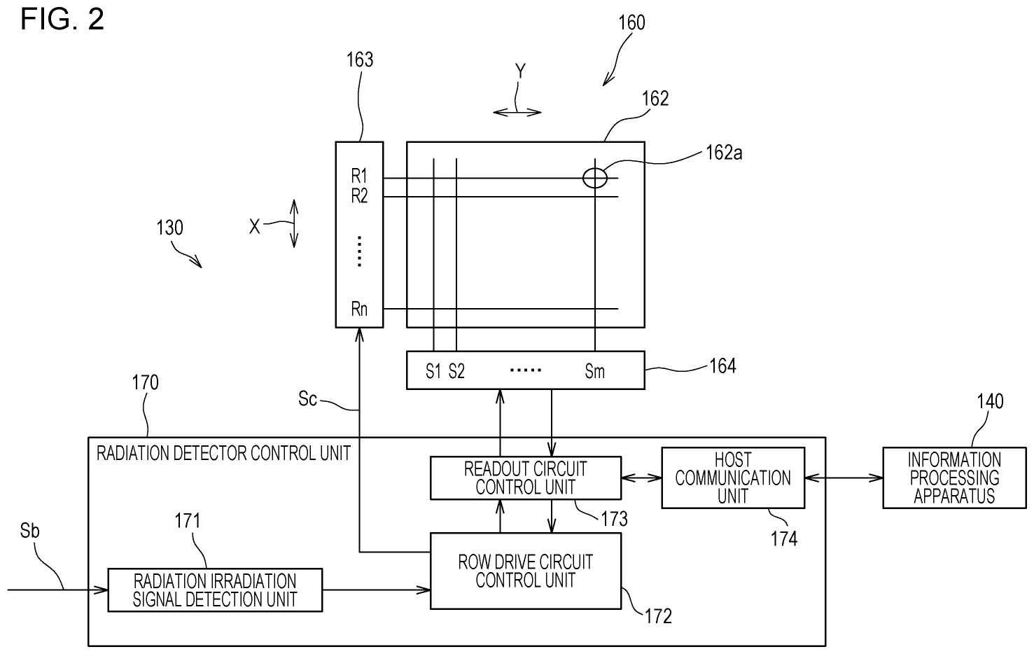

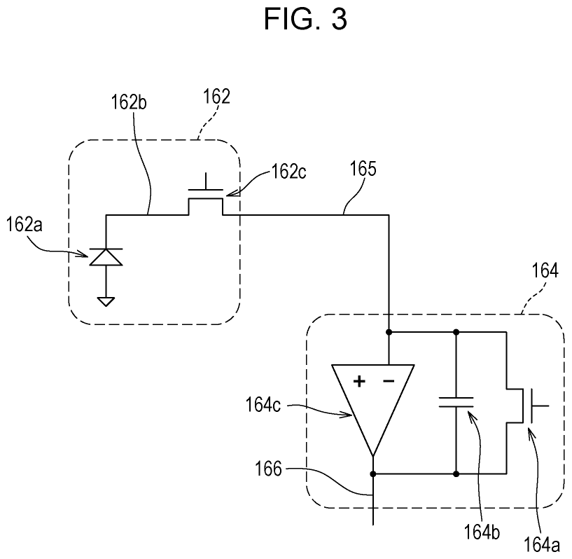

FIG. 2 is a block diagram showing a schematic configuration of the radiation detector 130 in the radiation transmission image acquisition system 100 shown in FIG. 1. FIG. 3 is a circuit diagram showing a configuration example of one photoelectric light receiving element 162a and a readout circuit 164 connected to the photoelectric light receiving element 162a in the sensor unit 160.

As shown in FIG. 2, the sensor unit 160 further includes a row drive circuit 163 and a readout circuit 164. The row drive circuit 163 selects the photoelectric light receiving elements 162a to 162a in the row direction X in the array unit 162. The readout circuit 164 reads out charges, which are accumulated in the photoelectric light receiving element 162a selected by the row drive circuit 163, in parallel in the column direction Y.

In this example, the sensor unit 160 employs a PPS (Passive Pixel Sensor) method that directly reads out charges accumulated in each photoelectric light receiving element 162a to 162a.

As shown in FIG. 3, the array unit 162 includes a charge accumulation portion 162b (charge accumulation node) and a readout switch 162c of the photoelectric light receiving element 162a.

The photoelectric light receiving element 162a accumulates the charges generated by the photoelectric conversion in the charge accumulation portion 162b. Thereby, charges according to the amount of incident light to the photoelectric light receiving element 162a are accumulated in the charge accumulation portion 162b.

One end of the readout switch 162c is connected to the charge accumulation portion 162b, and the other end is connected to a signal output line 165. The readout switch 162c switches between a cutoff state and a conductive state between the charge accumulation portion 162b and the signal output line 165 according to an instruction from a readout circuit control unit 173.

The readout circuit 164 includes a readout amplifier 164c for each connected column wiring, and outputs a digital value according to the charges accumulated in the photoelectric light receiving element 162a from a digital/analog conversion circuit (not shown in the drawings) located on the post-stage of the readout amplifier 164c.

The readout circuit 164 includes an amplifier reset switch 164a, a feedback capacitance 164b, and the readout amplifier 164c. An input terminal of the readout amplifier 164c is connected with the signal output line 165, one end of the feedback capacitance 164b, and one end of the amplifier reset switch 164a. An output terminal of the readout amplifier 164c is connected with a readout amplifier output line 166, the other end of the feedback capacitance 164b, and the other end of the amplifier reset switch 164a.

Thereby, when the readout switch 162c is switched to the conductive state, charges according to the amount of charges accumulated in the charge accumulation portion 162b are accumulated in the feedback capacitance 164b connected to the readout amplifier 164c in parallel. As a result, when an output potential from the readout amplifier 164c to the readout amplifier output line 166 is Vout, the amount of charges accumulated in the charge accumulation portion 162b is Qsig, and the feedback capacitance 164b is Cf, the output potential Vout is an output potential according to the amount of charges accumulated in the photodiode 162a as shown in the following formula (1).

Vout=Qsig/Cf (1)

In this case, the potential of the signal output line 165 is set to a predetermined potential by feedback of the readout amplifier 164c. When the readout is completed, the readout switch 162c is opened (turned off), connection between the charge accumulation portion 162b and the signal output line 165 is cut off, and charges are going to be accumulated in the charge accumulation portion 162b again.

As show in FIG. 2, the radiation detector control unit 170 includes a radiation irradiation signal detection unit 171, a row drive circuit control unit 172 (row selection control unit), a readout circuit control unit 173, and a host communication unit 174.

When the radiation irradiation signal detection unit 171 detects the presence or absence of transmission of the radiation irradiation signal Sb from the radiation irradiation apparatus control unit 111 (see FIG. 1) and detects the presence of the transmission of the radiation irradiation signal Sb, the radiation irradiation signal detection unit 171 instructs the row drive circuit control unit 172 to start row drive (row selection).

Hereinafter, an operation of the present embodiment will be described.

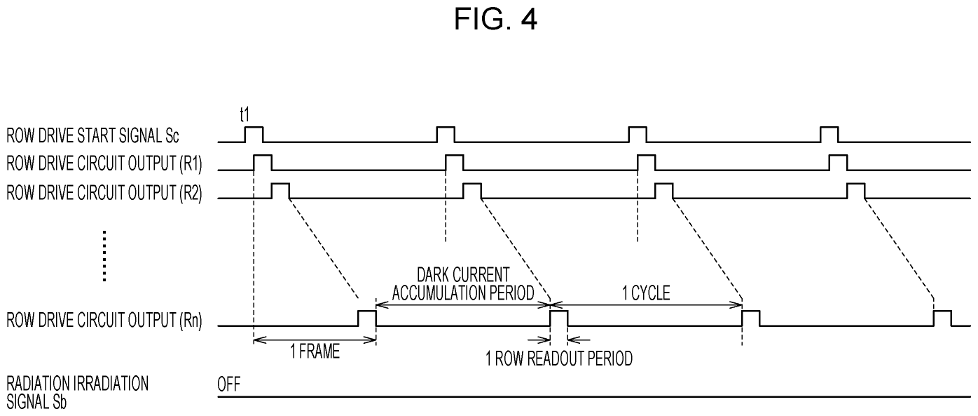

FIG. 4 is a timing chart showing drive timing of the photoelectric light receiving elements 162a to 162a in the radiation detector 130 in a state where no radiation is irradiated (during dark time).

Next, an reset operation that resets dark current accumulated in a state where there is no irradiation of radiation (resets charges generated by other than irradiation of radiation) will be described with reference to FIGS. 2 and 4.

There is no irradiation of radiation, so that the radiation irradiation signal detection unit 171 does not detect the radiation irradiation signal Sb. Therefore, the row drive circuit control unit 172 outputs a row drive start signal Sc to the row drive circuit 163 at predetermined intervals as shown in FIG. 4. The row drive circuit 163 outputs signals that sequentially activate rows of the photoelectric light receiving elements 162a to 162a (see R1 to Rn in FIGS. 2 and 4). Activated each row outputs charges accumulated in the photoelectric light receiving element 162a in the row to the readout circuit 164 (see S1 t Sm in FIG. 2). At this time, the photoelectric light receiving element 162a, from which charges are read out, loses charges and is reset. By repeating the operation described above, generated dark current is periodically reset.

In other words, the row drive circuit 163 selects (scans) the photoelectric light receiving elements 162a to 162a row by row at predetermined periods from the first row to the last row. Here, a period in which the row drive circuit 163 completes the selection of the rows from the first row to the last row is defined as one frame in the same manner as in the related art. In particular, one frame of an operation in which the rows from the first row to the last row have been selected at predetermined periods as described above is called a first period.

Next, an operation in a state where the radiation is irradiated will be described.

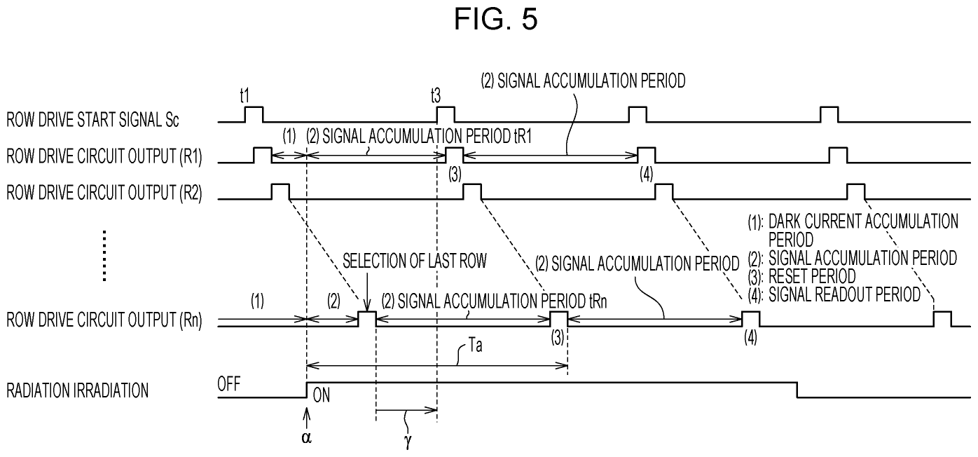

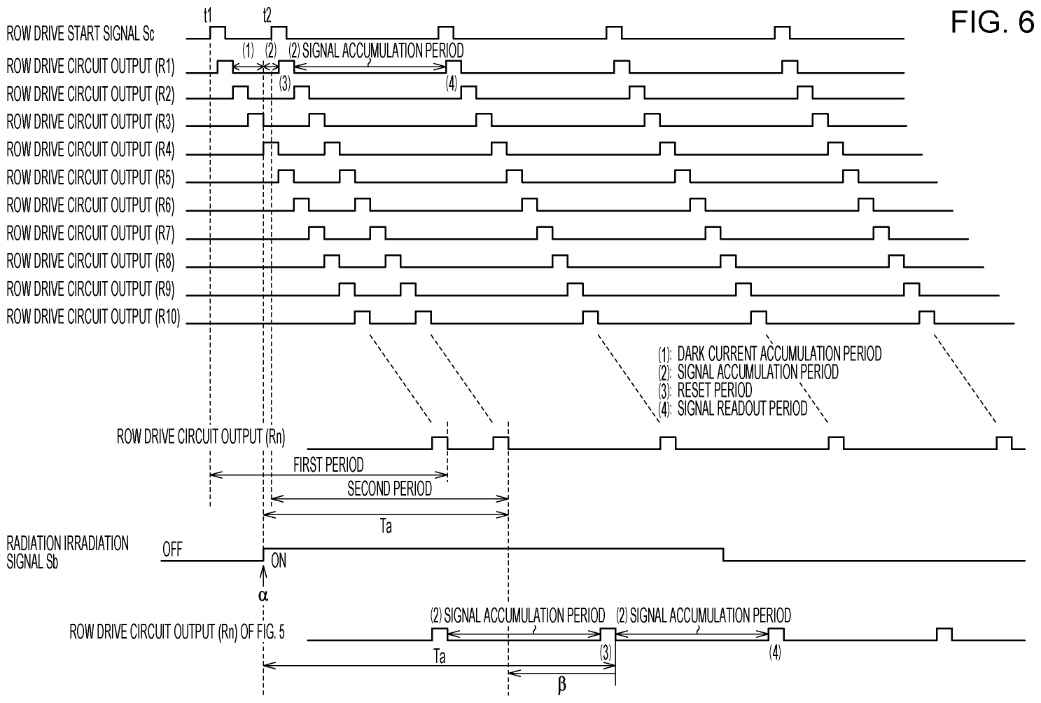

FIG. 6 is a timing chart showing drive timing of the present embodiment to the photoelectric light receiving elements 162a to 162a in the radiation detector 130 in a case where the radiation is irradiated. FIG. 5 shows an operation timing of a conventional circuit for explaining effects of the present embodiment.

A readout operation of charges when the radiation is irradiated will be described below with reference to FIGS. 2, 5, and 6.

In the conventional circuit, as shown in FIG. 5, when irradiation of radiation is started while rows are being selected (when radiation is irradiated while the middle of rows is selected) (see a in FIG. 5), a signal accumulation period tRl by radiation for each row and a signal accumulation period tRn are different, so that it is necessary to return to the first row, reset charges once for a reset period, and start accumulation of signal (signal charge) after the reset in order to equalize the signal accumulation periods. In other words, it is necessary to start drive of the first row by the row drive start signal Sc (t3) after γ after waiting until the last row is selected, and after resetting charges accumulated so far, it is necessary to accumulate signal (signal charge) by irradiation of radiation. In this case, if selection of the last row is completed and the next row drive start signal Sc is not outputted, selection of the first row cannot be started, so that a useless waiting time occurs accordingly.

Specifically, as shown in FIG. 5, output of the row drive circuit is started at a first time t1, and data from when the radiation irradiation is started (see a in FIG. 5) to a third time t3 when the next row drive start signal Sc is outputted is not data included in the entire image data, so that data from the third time t3 needs to be acquired as image data. In other words, the radiation irradiation period requires two frame periods or more, so that useless radiation irradiation period occurs.

In this way, a reset time Ta from when the radiation irradiation is started while the middle of a row is selected to when charges accumulated so far are reset after waiting until the last row is selected is considered, so that it is necessary to irradiate radiation for a time longer than necessary to acquire an inspection image.

On the other hand, in a drive timing of a circuit of the present embodiment shown in FIG. 6, when the radiation detector 130 detects the radiation irradiation signal Sb, the radiation detector 130 starts selection of rows from the first row regardless of selection state of row. Further, the radiation detector 130 starts selection of rows from the first row without waiting for completion of readout of one frame after reading out a signal (signal charge) accumulated by irradiation of radiation. By performing drive in this way, it is possible to start accumulation of signal (signal charge) by irradiation of radiation immediately after the radiation irradiation signal Sb is detected, so that it is possible to obtain an inspection image whose quality is equal to that of a conventional one while reducing radiation irradiation time to shorter than that of the conventional one.

Specifically, as shown in FIG. 6, the row drive circuit control unit 172 outputs the row drive start signal Sc to the row drive circuit 163 at fixed intervals as described in FIG. 4 until the radiation irradiation signal Sb turns on (see the first time t1 in FIG. 6). Even during the selection, when the radiation irradiation signal detection unit 171 detects the radiation irradiation signal Sb (see a in FIG. 6), the row drive circuit control unit 172 generates the row drive start signal Sc for the first row (see second time t2 in FIG. 6) and immediately outputs the row drive start signal Sc to the row drive circuit 163.

The row drive circuit 163 redoes row drive circuit outputs (R1 to Rn) from the beginning. Here, one frame, which is performed when radiation irradiation is detected and thereby the row drive circuit control unit 172 responds, is called a second period in order to differentiate from the first period described above. Thereby, the readout circuit 164 can start readout of the second period of a signal (signal charge) from the photoelectric light receiving element 162a immediately after the radiation irradiation signal Sb turns on, that is, immediately after the radiation is irradiated, so that the reset time Ta can be shortened accordingly. In FIG. 6, the timing in FIG. 5 is cited, and comparison of the reset time Ta is shown. As shown in FIG. 6, it is known that the reset time Ta is shortened by a β period. Therefore, readout of a signal when the radiation irradiation signal is received while rows are being selected can be completed quickly, so that it is possible to shorten the radiation irradiation period. Here, as shown in FIG. 6, in a period in which the first period and the second period overlap with each other, a plurality of selected rows occur. In FIG. 6, in the period in which the first period and the second period overlap with each other, a plurality of selected rows, such as a pair of the row drive circuit output R1 and the row drive circuit output R5, a pair of the row drive circuit output R2 and the row drive circuit output R6, a pair of the row drive circuit output R3 and the row drive circuit output R7, and so on, are generated.

Data that is read out by the readout circuit 164 is outputted from the readout circuit control unit 173 to the information processing apparatus 140 through the host communication unit 174.

When the row drive circuit control unit 172 detects the radiation irradiation signal Sb, the row drive circuit control unit 172 also notifies the readout circuit control unit 173 that the radiation irradiation signal Sb turns on. Thereby, it is possible to transmit a detection result (signal charge) of the sensor unit 160 to the host communication unit 174 only when there is irradiation of radiation.

### Second Embodiment

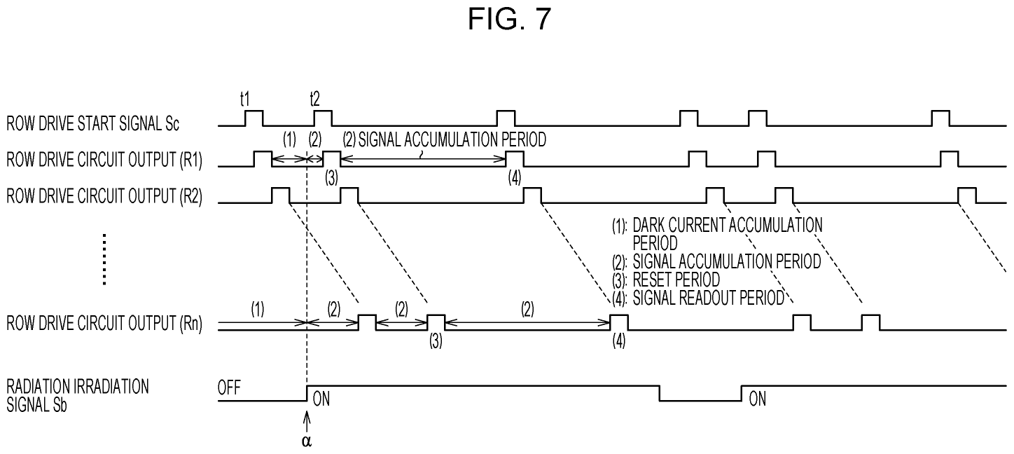

The radiation detector 130 according to the present embodiment can start selection of rows from the first row without waiting for completion of readout of one frame which is a period where selection of rows from the first row to the last row is completed, so that, as shown in FIG. 7, it is possible to perform irradiation of radiation and acquire a radiation transmission image without considering a reset period of dark current after signal accumulation and signal readout are completed after the radiation irradiation is performed.

### Third Embodiment

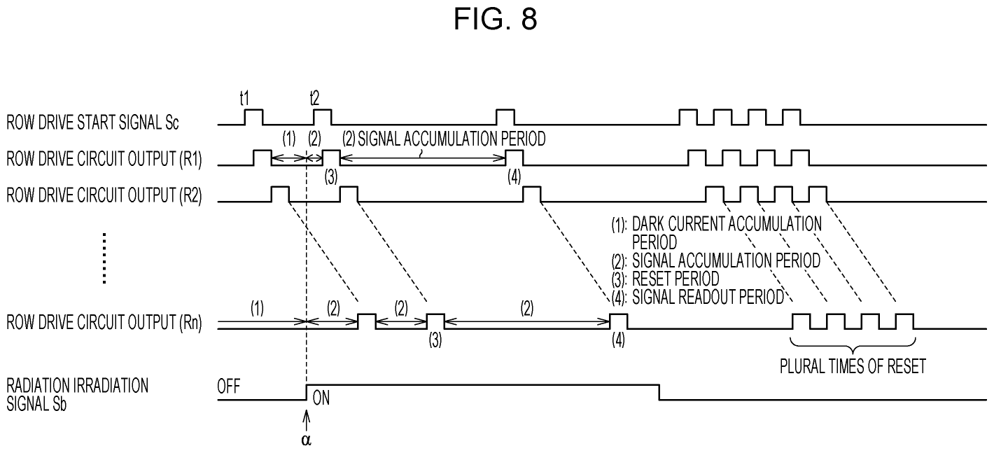

A lot of charges are accumulated in the sensor unit 160 by the signal accumulation performed after the radiation irradiation. Although almost all charges are transferred to the readout circuit 164 by the readout operation, some charges remain. These charges affect the next readout and are detected as an afterimage. To prevent generation of the afterimage, as shown in FIG. 8, after signal readout after the radiation irradiation, charges are reset by performing readout a plurality of times in a short period of time.

Even in such a period where readout is performed a plurality of times, the radiation detector 130 according to the present embodiment restores a drive frequency and performs accumulation and readout of charges when radiation is irradiated.

The present disclosure is not limited to the embodiments described above but can be implemented in other various forms. Therefore, the embodiments are merely illustrations in every way, so that the embodiments should not be restrictively interpreted. The scope of the disclosure is shown by the claims and is not restricted by the text of the specification. Further, all of modifications and variations belonging to the equivalent range of the scope of the claims are within the scope of the disclosure.

The present disclosure contains subject matter related to that disclosed in Japanese Priority Patent Application JP 2018-094805 filed in the Japan Patent Office on May 16, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A radiation detector where elements that detect radiation and generate charges are arranged in a matrix form and which selects and reads out charges, which correspond to a dose of the radiation, row by row at predetermined periods, wherein
the radiation detector starts selection of rows from a first row without waiting for completion of readout of one frame which is a period where selection of rows from the first row to a last row is completed.

2. The radiation detector according to claim 1, wherein
the radiation detector detects radiation that transmits through an inspection object, and
the radiation detector starts selection of rows from the first row by detecting that radiation is irradiated to the inspection object.

3. The radiation detector according to claim 2, wherein
in a period in which there is not the detection of radiation, the radiation detector starts selection of rows from the first row at fixed intervals.

4. The radiation detector according to claim 3, wherein
the radiation detector resets charges generated by other than the irradiation of radiation by the selection of rows from the first row at fixed intervals.

5. A radiation transmission image acquisition system comprising:
the radiation detector according to claim 2; and
an information processing apparatus that processes charges read out by the radiation detector into an image, wherein
the radiation detector transfers the read-out charges to the information processing apparatus only when radiation irradiation to the inspection object is detected.

6. A radiation detector where elements that detect radiation and generate charges are arranged in a matrix form and which detects radiation that transmits through an inspection object, the radiation detector comprising:
a first period in which readout of one frame, which is a period where the charges are selected row by row at predetermined periods and selection of rows from a first row to a last row is completed, is performed;
a second period in which selection from the first row is started by detecting that the radiation is irradiated to the inspection object, and the readout of one frame, which is a period where the charges are selected row by row at predetermined periods and selection of rows from the first row to the last row is completed, is performed, wherein
the second period starts without waiting for end of the first period, and
a plurality of selected rows occur in a period in which the first period and the second period overlap with each other.

7. The radiation detector according to claim 6, wherein
in the first period, charges generated by other than the irradiation of radiation are reset.

8. A radiation transmission image acquisition system comprising:
the radiation detector according to claim 6; and
an information processing apparatus that processes charges read out by the radiation detector into an image, wherein
the radiation detector transfers the read-out charges to the information processing apparatus only when radiation irradiation to the inspection object is detected.

9. A radiation detector where elements that detect radiation and generate charges are arranged in a matrix form and which selects and reads out charges, which correspond to a dose of the radiation detected from an inspection object to which the radiation is irradiated, row by row at predetermined periods, wherein
after reading out signals accumulated by the irradiation of radiation, the radiation detector starts selection of rows from a first row without waiting that charges are reset by readout of one frame which is a period where selection of rows from the first row to a last row is completed.
